(19) United States
(12) Patent Application Publication
(10) Pub. No.: US 2006/0268940 A1
(43) Pub. Date: Nov. 30, 2006

(54) Apparatus for extending a serial port interface

(75) Inventors: Chin-Sung Hsu, Taipei (TW); Ching-Chih Lin, Taipei (TW); Hsu-Hsun Tsai, Taipei (TW)

Correspondence Address: BIRCH STEWART KOLASCH & BIRCH, PO BOX 747, FALLS CHURCH, VA, 22040-0747, US

(73) Assignee: Asmedia Technology Inc.

(21) Appl. No.: 11/418,262

(22) Filed: May 5, 2006

(30) Foreign Application Priority Data
May 31, 2005 (TW) 94117886

(51) Int. Cl. H04J 3/08

(52) U.S. Cl. 370/502; 370/524

(57) ABSTRACT

A serial port interface extending apparatus used in an electronic device comprises a serial signal processing unit, a signal switching unit and a plurality of serial port interfaces. The serial port interfaces are all connected to the signal switch unit. The serial signal processing unit controls the signal switch unit to select one of the serial port interfaces to be connected to the serial signal processing unit.

### RELATED APPLICATIONS

The present application is based on, and claims priority from, Taiwan Application Serial Number 94117886, filed May 31, 2005, the disclosure of which is hereby incorporated by reference herein in its entirety.

### BACKGROUND

1. Field of Invention

The present invention relates to an interface extending apparatus. More particularly, the present invention relates to an interface extending apparatus of serial port.

2. Description of Related Art

The progress in design and manufacturing techniques of electronic devices has led to a gradual increase in the variety of available electronic devices. For example, a personal computer (PC) and a personal digital assistant (PDA) are both able to process many types of digital data, a digital camera is able to process video data and a network phone system is able to process speech and sound data. The workload of modern electronic devices is therefore subdivided among different data types, and the requirement of connecting and communicating between various electronic devices has increased. For example, the capacity of a memory card in a digital camera is not very large in general, and hence, the digital camera should be able to connect to an electronic device with a larger storage space such as a PC or an electronic storage device for moving the pictures stored in the digital camera to the larger storage space when the sum of the storage sizes of the pictures on the camera equals the storage capacity of the memory card. The digital camera can also connect to an electronic developing and printing device for directly developing and printing the pictures stored in the digital camera.

It can be seen from the foregoing example, an electronic device may transmit data to various other electronic devices. Therefore, if there have no any common data transmission standard used between two electronic devices, data will be hard to be transmitted between those two electronic devices. Especially, the size and transmission rate of some conventional data transmission interfaces are too large and slow to be used in the electronic device nowadays under the trend of miniaturization of the electronic devices.

Because the area of data transmission interface can be effectively reduced by using the serial type data transmission, various serial transmission interface standards are developed, such as the Universal Serial Bus (USB) and the IEEE 1394 standards. These serial transmission interface standard also can be operated under a very high speed in the advanced electronic technique; hence, they are very suitable for use in various electronic devices.

FIG. 1 shows a diagram of two electronic devices using serial transmission interface to carry out a data transmission. An electronic device 100 has several serial signal processing units 102 and several serial port interfaces 104 correspondingly connected to the serial processing units 102. An electronic device 110 has several signal processing units 112 identical with the signal processing units 102 and several serial port interfaces 114 correspondingly connected to the serial processing units 112. Each of the serial port interfaces 104 and 114 is used to connect to another identical external serial port interface. When one of the serial port interfaces 104 is connected to one of the serial port interfaces 114 with a line 120, the corresponding serial signal processing units 102 and 112 will carry out a data transmission between the electronic devices 100 and 110 via the connected serial port interfaces 104 and 114.

It can be seen that using the serial transmission interface to carry out the data transmission between electronic devices is very speedy and convenient. Because one electronic device may be connected to many other electronic devices at the same time, several serial transmission ports may be installed into one electronic device, and these serial transmission ports will also occupy a large area in the electronic device, especially the miniature portable electronic device.

Besides, it can be seen in FIG. 1, one serial signal processing unit is corresponding to only one serial port interface in general. The amount of serial signal processing unit should be increased if the amount of serial port interface desires to be increased. That is to say, when an electronic device is manufactured, the amount of serial signal processing unit and serial port interface in the electronic device is following to be determined and hard to be changed. The flexibility in design is lacked.

### SUMMARY

It is therefore an objective of the present invention to provide a serial interface extending apparatus used in an electronic device.

It is another objective of the present invention to provide a small-sized serial interface extending apparatus.

It is still another objective of the present invention to provide a serial interface extending apparatus with highly flexible design.

It is another objective of the present invention to provide an electronic device with several serial ports.

According to the foregoing objectives of the invention, a serial port extending apparatus according to an embodiment of the present invention comprises a serial signal processing unit, a signal switching unit and a plurality serial port interfaces. The serial port interfaces are connected to the signal switching unit. The serial signal processing unit issues a switch signal to control the signal switching unit to connect one of the serial port interfaces and the serial signal processing unit.

In another embodiment of the present invention, the serial signal processing unit further has an “on the go” (OTG) function. That is to say, the data from a serial port interface (source serial port interface) can be directly transmitted to another serial port interface (target serial port interface) by the control of the serial signal processing unit and the switching of the signal switching unit, without passing through any other units of the electronic device. A memory unit used to support the function of OTG is needed. The memory unit can temporarily store the data from the source serial port interface, and then transmit the data to the target serial port interface when the signal switching unit is switched to the target serial port interface. The memory unit may be built-in into the serial signal processing unit or an independent memory device.

### BRIEF DESCRIPTION OF THE DRAWINGS

These and other features, aspects, and advantages of the present invention will become better understood with regard to the following description, appended claims, and accompanying drawings, where:

FIG. 1 is a transmission diagram of a conventional serial data transmitting apparatus;

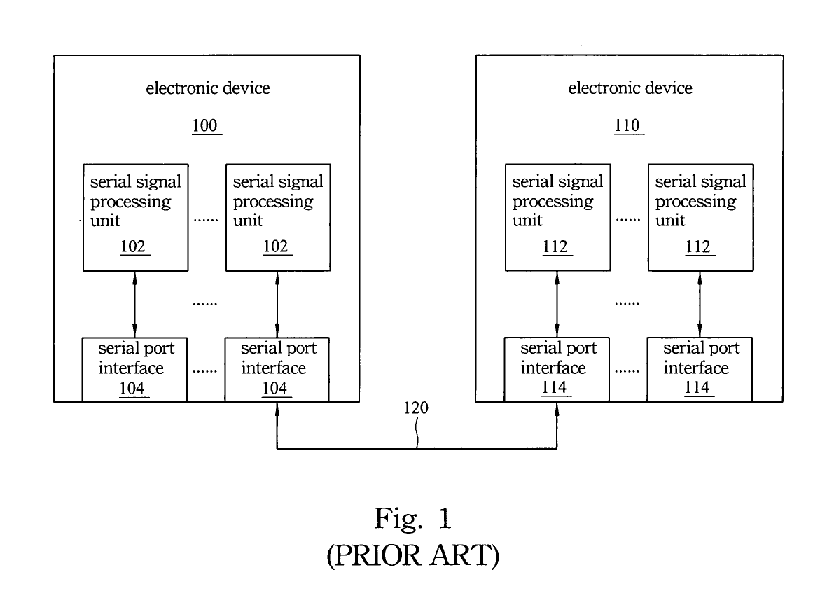

FIG. 2 is a diagram of a serial port interface extending apparatus according to an embodiment of the present invention.

FIG. 3 is a flow chart of a data transmitting method according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the conventional serial port transmitting interface, a serial port interface must be controlled by one serial signal processing unit then a data transmission operation can be regularly carried out. Therefore, if there are several serial port interfaces disposed on an electronic device, a sizeable area of the electronic device will be occupied by several serial signal processing units. Therefore, the basic concept of the present invention is to use a signal switching circuit so that one serial signal processing unit is able to support data transmissions of more than two serial port interfaces.

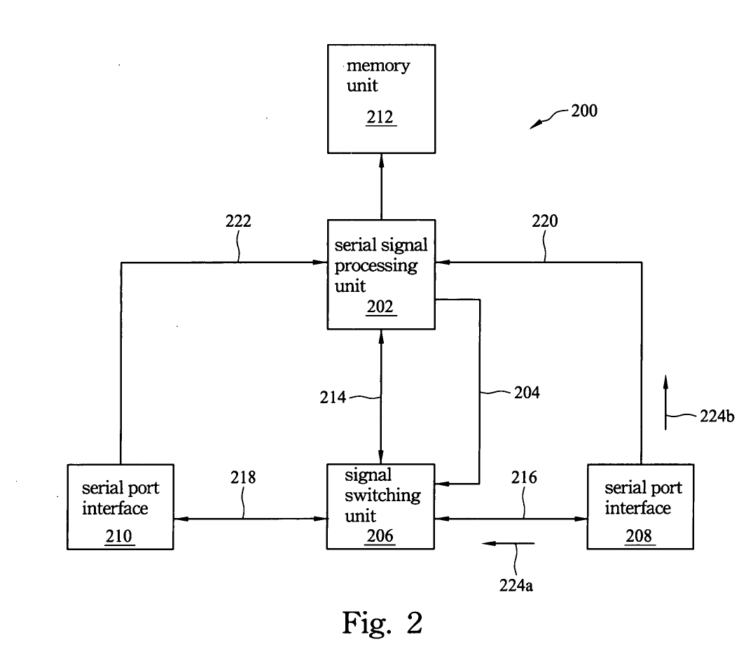

FIG. 2 shows a serial port interface extending apparatus 200 according to an embodiment of the invention. The serial port interface extending apparatus 200 may be used in an electronic device (not shown in the figure), wherein the electronic device may be a personal computer (PC), a personal digital assistant (PDA) or a digital camera. The serial port extending apparatus 200 comprises a serial signal processing unit 202, a signal switching unit 206 and several serial port interfaces (as serial port interfaces 208 and 210 shown in FIG. 2).

In general, the signal switching unit 206 is connected to the external signal lines. Therefore, the signal switching unit 206 is able to determine the connecting configuration between these external signal lines. In the serial port interface extending apparatus 200, the serial signal processing unit 202, the serial port interfaces 208 and 210 are connected to the signal switching unit 206 via lines 214, 216 and 218 respectively. Hence, depending on the switching operation of the signal switching unit 206, the serial signal processing unit 202 and the serial port interface 208 can be connected to each other, or the serial signal processing unit 202 and the serial port interface 210 can be connected to each other.

Both of the serial port interfaces 208 and 210 are the connecting interfaces, such as universal serial bus (USB) and IEEE 1394 interface, used to connect to other electronic devices. When the serial port interface 208 is connected to another electronic device and attempts to set up a data transmission, the signal switching unit 206 will connect the lines 214 and 216. Then, the serial signal processing unit 202 is able to carry out the data transmission by the serial port interface 208. Similarly, when the serial port interface 210 is connected to another electronic device and attempts to set up a data transmission, the signal switching unit 206 will connect the lines 214 and 216. Then, the serial signal processing unit 202 is able to carry out the data transmission by the serial port interface 208.

The serial signal processing unit 202 alternately processes the data transmissions from the serial port interfaces 208 and 210. However, the user can still feel that the two data transmissions are carried out at the same time because both the switching operation and the serial data transmission of the circuit are very fast.

Therefore, the serial signal processing unit 202 should operate with the signal switching unit 206, and the serial signal processing unit 202 is able to control the signal switching unit 206 for determining a desired data path. When a data transmission request is issued from the serial port interface 208 and received by the serial signal processing unit 202, a first control signal will be issued from the serial signal processing unit 202 via a line 204 for controlling the signal switching unit 206 to connect the line 214 and 216. Similarly, when a data transmission request issued from the serial port interface 210 is received by the serial signal processing unit 202, a second control signal will be issued from the serial signal processing unit 202 via the line 204 for controlling the signal switching unit 206 to connect the line 214 and 218.

Many methods can be used in the serial signal processing unit 202 to determine whether the data transmission request is issued from the serial port interfaces 208 or 210. For example, the signal switching unit 206 may periodically and alternately switch between the lines 216 and 218. That is to say, the signal switching unit 206 may periodically and alternately connect lines 214 and 216, or connect the lines 214 and 218. When a data transmission request 224a issued from the serial port interface 208 is received by the serial signal processing unit 202, the serial signal processing unit 202 will control the signal switching unit 206 to stop the switching operation via the line 204. Then, the serial signal processing unit 202 and the serial port interface 208 that issued the data transmission request 224a can be connected with each other.

Besides, the serial port interface 208 and 210 may respectively use notice lines 220 and 222 to issue data transmission requests. For example, the serial port interface issues a data transmission request 224b to the serial signal processing unit 202 via the notice line 220. Then, the serial signal processing unit 202 controls the signal switching unit 206 via the line 204 to connect the serial signal processing unit 202 and the serial port interface 208 issued the data transmission request 224b. In the embodiment, the signal switching unit 206 may be a quick switch and may comprise of several transistors, it is able to selectively switch the electric signal path.

The “on the go” (OTG) function is generally implemented in the serial signal processing unit, such as USB. The OTG function allows two of the serial port interfaces installed in the same electronic device to directly transmit data to each other without passing through any other units in the electronic device.

Referring to the system framework shown in FIG. 2, in general, the serial signal processing is connected to a peripheral control unit (not shown in the figure) that is used to control each of the data input and output units, including serial data transmission units, of the electronic device. If data must be transmitted from the serial port interface 208 to serial port interface 210 and the serial signal processing unit 202 does not have the function of OTG, the serial signal processing unit 202 will transmit the data to the peripheral control unit of the electronic device for the further processing first. Then, the serial signal processing unit 202 will transmit the data to the serial port interface 210 when the peripheral control unit transmits the data back. But if the serial signal processing unit 202 has the OTG function, it can directly transmit the data received from the serial port interface 208 to the serial port interface 210.

A memory unit 202 should be applied into the extending apparatus 200 to support the OTG function in the serial signal processing unit 202. The memory unit 212 may be an independent unit that can be accessed by the serial signal processing unit 202 or a memory device built-in to the serial signal processing unit 202. In the embodiment, the memory unit 212 is an independent unit, and it can thus have a larger storage space. The memory unit 212 is used to temporarily store the data transmitted with the OTG operation. When the serial signal processing unit 202 and the serial port interface 208 are connected with each other, the serial signal processing unit 202 will store the data into the memory unit 212 at first. Then, the serial signal processing unit 202 will transmit the data stored in the memory unit 212 to the serial port interface 210 when the serial signal processing unit 202 and the serial port interface 210 are connected with each other. Thus, the OTG function is procured.

The serial port interface extending apparatus 200 according to the foregoing embodiments of the present invention can be implemented into any electronic device that has a requirement to transmit data, wherein the amount of serial port interface connected to the signal switching unit 206 depends on the connection capability of the signal switching unit and its practical application, it is not limited by the embodiments of the present invention.

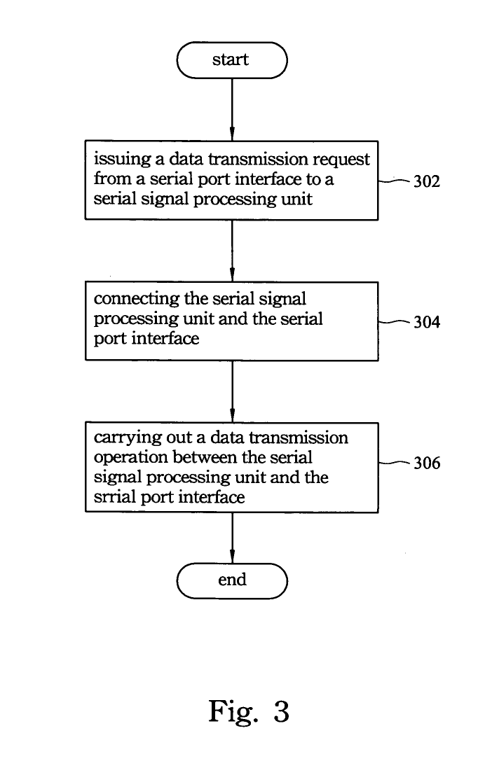

Summing up the foregoing description, a flow chart of a data transmitting method used in the serial port interface extending apparatus according to the embodiment of the present invention is shown FIG. 3, wherein the serial port interface comprises a serial signal processing unit and several serial port interfaces. In the step 302, a data transmission request is issued from one of the serial port interfaces to the serial signal processing unit. In the step 304, the serial signal processing unit receives a data transmission request connected to the serial port interface issued the data transmission request. In step 306, a data transmission operation can be carried out between the signal processing unit and the serial port interface connected to each other.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A serial port extending apparatus, comprising:
a serial signal processing unit used to carry out a data transmission operation;
a plurality of serial port interfaces;
a signal switching unit, wherein the signal switching unit is connected to the serial signal processing unit and selectively connected to one of the serial port interfaces,
wherein the serial signal processing unit controls the signal switching unit according to a control signal for connecting the serial signal processing unit and one of the serial port interfaces, and then the data transmission operation can be carried out.

2. The serial port interface extending apparatus as claimed in claim 1, wherein the data transmission operation conforms to the universal serial bus (USB) or IEEE 1394 standard.

3. The serial port interface extending apparatus as claimed in claim 1, further comprising a notice line between the serial signal processing unit and each of the serial port interfaces, wherein the notice line is used by the serial port interface to issue a data transmission request to the serial signal processing unit.

4. The serial port interface extending apparatus as claimed in claim 1, wherein the serial signal processing unit has the “on the go” (OTG) function.

5. The serial port interface extending apparatus as claimed in claim 4, further comprising a memory unit accessed by the serial signal processing unit, wherein the memory unit is an independent unit or built into the serial signal processing unit.

6. A method for using a serial signal processing unit to control a plurality of serial port interfaces in a serial data transmitting apparatus, comprising:
issuing a data transmission request from a first serial port interface of the serial port interfaces to the serial signal processing unit;
connecting the serial signal processing unit and the first serial port interface; and
carrying out a data transmission operation between the serial signal processing unit and the first serial port interface.

7. The method as claimed in claim 6, wherein in the issuing step, the serial signal processing unit receives the data transmission request from the first serial port interface by periodically and alternately connecting the serial signal processing unit and each of the serial port interfaces.

8. The method as claimed in claim 6, wherein in the issuing step, a notice line is used by the first serial port unit to issue the data transmission request to the serial signal processing unit.

9. The method as claimed in claim 6, wherein in the connecting step, the serial signal processing unit and the first serial port interface are connected with each other by switching a signal switching unit.

10. The method as claimed in claim 6, wherein the data transmission operation conforms to the universal serial bus (USB) or IEEE 1394 standard.
